(19) United States
(12) Patent Application Publication
(10) Pub. No.: US 2009/0077617 A1
(43) Pub. Date: Mar. 19, 2009

(54) Automated generation of spam-detection rules using optical character recognition and identifications of common features

(76) Inventors: Zachary S. Levow, Mountain View, CA (US); Shawn Paul Anderson, Vancouver, WA (US); Dean M. Drako, Los Altos, CA (US)

Correspondence Address: Terry McHugh;Law Offices of Terry McHugh, 101 First Street - PMB 560, Los Altos, CA, 94022, US

(21) Appl. No.: 11/900,741

(22) Filed: Sep. 13, 2007

(51) Int. Cl. G06F 21/00

(52) U.S. Cl. 726/1

(57) ABSTRACT

In a spam detection method and system, optical character recognition (OCR) techniques are applied to a set of images that have been identified as being spam. The images may be provided as the initial training of the spam detection system, but the preferred embodiment is one in which the images are provided for the purpose of updating the spam-detection rules of currently running systems at different locations. The OCR generates text strings representative of content of the individual images. Automated techniques are applied to the text strings to identify common features or patterns, such as misspellings which are either intentionally included in order to avoid detection or introduced through OCR errors due to the text being obscured. Spam-detection rules are automatically generated on the basis of identifications of the common features. Then, the spam-detection rules are applied to electronic communications, such as electronic mail, so as to detect occurrences of spam within the electronic communications.

### TECHNICAL FIELD

The invention relates generally to spam detection methods and systems and relates more particularly to techniques for forming spam-detection rules.

### BACKGROUND ART

The ability of a person to receive electronic communications generated by others provides both social and business advantages. Electronic mail (“email”) and instant messaging are two forms of electronic communications that enable individuals to quickly and conveniently exchange information with others. On the other hand, the existence of such communications provides opportunities for e-marketers, computer hackers and criminal organizations. Most commonly, the opportunities are provided by the ability to transmit “spam,” which is defined herein as unsolicited messages. With respect to email, spam is a form of abuse of the Simple Mail Transfer Protocol (SMTP).

Initially, spam was merely an inconvenience or annoyance. However, spam soon became a significant security issue for individuals and for employers of the targeted individuals. A spam email may include a virus or a “worm” which is intended to affect operation or performance of a device. At times, spam is designed to induce a reader to disclose confidential personal or business-related information. Additionally, even unharmful spam is a financial drain to large corporations. Well over fifty percent of all email traffic directed to individuals of a particular corporation is likely to be spam.

With reference to FIG. 1, a spam firewall 10 may be used to block unwanted email from reaching an email server 12 of a network. The email server 12 represents the capability of the network to process incoming and outgoing email messages to and from client devices 14, 16 and 18. The client devices may be desktop or laptop computers, personal digital assistants (PDAs), or other devices capable of handling email. While there are many network configurations, a corporate firewall is typically located between the email server and a router to the global communications network referred to as the Internet. The standard deployment of a spam firewall is to assign the firewall a particular Internet Protocol (IP) address. Then, email messages are routed through the spam firewall.

A spam firewall may use a collection of different techniques in order to maximize the likelihood that spam will be properly identified. For example, the spam firewall commercially available from Barracuda Networks employs at least ten defense layers through which each email message must pass in order to reach the inbox of the intended user. One known technique for a defense layer is to use a word filter that identifies email containing specific keywords or patterns indicative of spam. The name of a particular drug may be within the library of words or patterns of interest to the word filter. A concern with simple word filtering is that it is susceptible to “false positives,” which are defined as misidentification of legitimate email as spam. For example, a pharmacist or physician is likely to receive email messages that include the name of the drug often used in spam email messages.

A more sophisticated technique used for spam blocking is rule-based scoring. Again, keyword or pattern searching and identification are used. However, rather than identifying each word/phrase as having a keyword as being spam, a point system is used. An email that contains the term “DISCOUNT” in all capital letters may receive two points, while the use of the phrase “click here” may receive a single point. The higher the total score, the greater the probability that the email is spam. A threshold value is selected to minimize the likelihood of false positives, while effectively identifying spam. Other known techniques are the use of Bayesian filters, which can be personalized to each user, identification of IP addresses of known spammers (i.e., a “blacklist”), a list of IP addresses from which an email message will be accepted (i.e., a “whitelist”), and various lookup systems.

In order to defeat techniques based upon detection of keywords, spam is increasingly sent in the form of images. The text within an image will not be recognized by conventional word filters. However, in order to meet this challenge, spam firewalls may be enabled with optical character recognition capability. Patent publication No. 2005/0216564 to Myers et al. describes a method and apparatus for providing analysis of an electronic communication containing imagery. Extraction and rectification of embedded text within the imagery is followed by optical character recognition processing as applied to regions of text. The output of the processing may then be applied to conventional spam detection techniques based upon identifying keywords or patterns.

The known techniques for providing spam detection operate well for their intended purpose. However, persons interested in distributing spam attempt to increase the deceptiveness of the content with each advancement in the area of spam detection. Originally, image spam often appeared to be a standard text-based email message, so that only a careful view would reveal that the message was merely an image displayed as a result of HTML code embedded within the email. As spam detection solutions became efficient in identifying image spam, spammers made adjustments which reduced the deceptiveness to users but increased the deceptiveness with regard to filters. For example, the optical character recognition approach was rendered less effective by offsetting letters within a line of text. Speckles or other forms of “graffiti” were added to an image in order to increase deceptiveness. Further improvements in detecting image spam are desired.

### SUMMARY OF THE INVENTION

In a spam detection method and system in accordance with the invention, spam-detection rules are automatically generated following a combination of applying optical character recognition (OCR) techniques to a set of known spam images and identifying common features and/or patterns within the text strings generated by the OCR processing. The set of images may be provided as the initial training of the spam detection system, but the preferred embodiment is one in which the images are provided for the purpose of updating spam-detection rules of currently running systems at various locations. The set of images may be a collection of spam images which previously were undetected by the system. The common features or patterns may be misspellings which were either intentionally included in order to avoid detection or inadvertently introduced through OCR errors as a consequence of text being obscured.

In effect, the system is a rule generation engine comprising an OCR component, a feature/pattern recognition component, and a component which is responsive to the feature/pattern recognition component to automatically generate spam-detection rules. The components may be purely software or a combination of computer software and hardware. The method is “computer-implemented,” which is defined herein as a method which is executed using a device or multiple cooperative devices driven by computer software. The implementation may be at a centralized location that supports spam detection for a number of otherwise unrelated networks or may be limited to a single network. Particularly when the invention is applied within a single network, the implementation may be at a firewall, a gateway, a dedicated server, or any network node that can exchange data with the spam detection capability of the network.

As a first step, a set of spam images is collected. For the embodiment in which images are provided for the purpose of updating spam-detection rules of currently running systems, the set of spam images may be submitted by administrators of the currently running systems as examples of spam which went undetected using the current (pre-updated) spam-detection rules. As another possibility, the set of images may be obtained from “honeypots,” i.e., computer systems expressly set up to attract submissions of spam and the like. The current spam-detection rules may be partially based upon the use of OCR processing and other effective techniques at the firewall, but with imperfections that were exploited by persons intending to widely distribute spam. Thus, the spam images that are used to enable rule updates may be considered “false negatives.”

After a library of spam images has been collected, the OCR processing is applied to the library in order to form at least one text string for each image. Conventional OCR processing may be employed. The conventional approach in OCR processing is to identify a baseline for a line of text. When each letter within a sentence is aligned relative to the baseline, the OCR processing operates well in identifying words. However, one technique used by spammers is to misalign the letters which form a word. Then, conventional OCR processing is prone to error. For example, a letter “O” that is misaligned from the baseline may be improperly identified as the Greek letter “φ.” Another common technique for avoiding spam detection is to intentionally misspell words, particularly words that are likely to be keywords used in word filtering or rule-based scoring for identifying spam. As an example, the name of a particular drug may be intentionally misspelled. Such misspellings do not necessarily involve the substitution of an incorrect letter for a correct letter. The misspelling may be a substitution of a symbol (e.g., “an asterisk”) for a letter.

The OCR processing forms a text string for any spam image that is recognized as having text. In some embodiments, spam images are segmented, so that multiple text strings will be generated per image. Common features and common images among the text string are then identified. In the above examples, the Greek letter “φ” may be in a number of different spam images and the misspelling of the name of the particular drug may be repeatedly included within different text strings. The common patterns may include particular phrases.

Algorithms may be applied to selectively identify the common features/patterns as being indicative of spam. As one possibility, a “frequency of occurrence” algorithm may be applied, such as the determination that when a threshold of fifty occurrences of an unidentified word have been detected, the word will be added to a “blacklist” of words or will be assigned a particular point value within rule-based scoring. Alternatively or additionally, a “similarity to existing rule” algorithm can be applied in order to optimize the current rules. That is, existing rules may be modified on the basis of outputs of the OCR processing. Thus, if a minor spelling variation is detected between a blacklisted word and the text of a threshold number of spam images, the related blacklist rule can be modified accordingly. The modification can be an expansion of the rule based on logical continuation, such as a determination that the spam images include regular number increments within or following a word that indicates spam (e.g., VIAGRA2, VIAGRA3, VIAGRA4 . . . can trigger a rule optimization to VIAGRA*). Modifications may “collapse” existing rules. For example, if the text strings that are acquired from the spam images show a pattern of misspelling a blacklisted word by replacing the final letter within the word, the relevant blacklist rule can be modified to detect the sequence of letters regardless of the final letter. Word searching using truncation is known in the art.

Bayesian techniques may be applied to the process of generating new or modified (optimized) rules on the basis of patterns and features detected within the text strings formed during the OCR processing. Previously, Bayesian filtering merely was applied directly to messages to distinguish spam email from legitimate email. Within this previously known application of Bayesian techniques, probabilities are determined as to whether email attributes, such as words or HTML tags, are indicative of spam. Tokens are formed from each of a number of legitimate messages and a number of spam messages. The probabilities are adjusted upwardly for words within the “bad” tokens, while the probabilities are adjusted downwardly for words within the “good” tokens. In comparison, the present invention utilizes the Bayesian analysis to determine the probability of appropriateness of rule modifications or rule additions as applied to images. While not critical to the implementation, in addition to spam images which were “false negatives” during spam detection, network administrators and end users may provide legitimate email images, particularly if they are “false positives.” From the two sets of images, probabilities can be established. Then, the probabilities can be applied to possible new or modified rules before actual use of the rules. For example, a threshold of probability may be established, so that rules are automatically rejected if the probability threshold is not reached.

Rule updating may also take place using images which are not known to be either spam images or spam-free images. Auto-learning is a possibility. If the OCR processing repeatedly detects a distinct text pattern, the text pattern may be identified as being “suspect.” Upon reaching a threshold number of detections of the text pattern, a spam rule may be generated that identifies the text pattern as being indicative of spam. As an alternative, the suspect text pattern may be tested against standard text-only email to potentially identify a correlation between the text pattern and a rule that applies to “text only” emails. As a third alternative, each suspect text pattern may be presented to a human administrator who determines the appropriateness of updating the current rules.

The new or modified rules can then be used as updates for the currently running spam detection system at one or more location. Such security updates of spam definitions may be activated automatically, with respect to both the transmission of the updated spam-detection rules from the source location and the loading of the rules at destination locations of the updates. Consequently, spam firewalls at various locations can be effectively managed from a central site.

Conventionally, spam-detection rules are used in the identification of spam among electronic communications, such as email. However, the present invention reverses this relationship, since the spam that was undetected by application of current rules is used in the identification of spam-detection rules.

### BRIEF DESCRIPTION OF THE DRAWINGS

FIG. 1 is a representation of one possible connection of a spam firewall to which updates in accordance with the invention may be applied.

FIG. 2 is a centralized system for providing updates of spam definitions in accordance with the invention.

FIG. 3 is a schematic view of a rule generation engine in accordance with the invention.

FIG. 4 is one embodiment of a process flow of steps for execution at the rule generation engine of FIG. 3.

### DETAILED DESCRIPTION

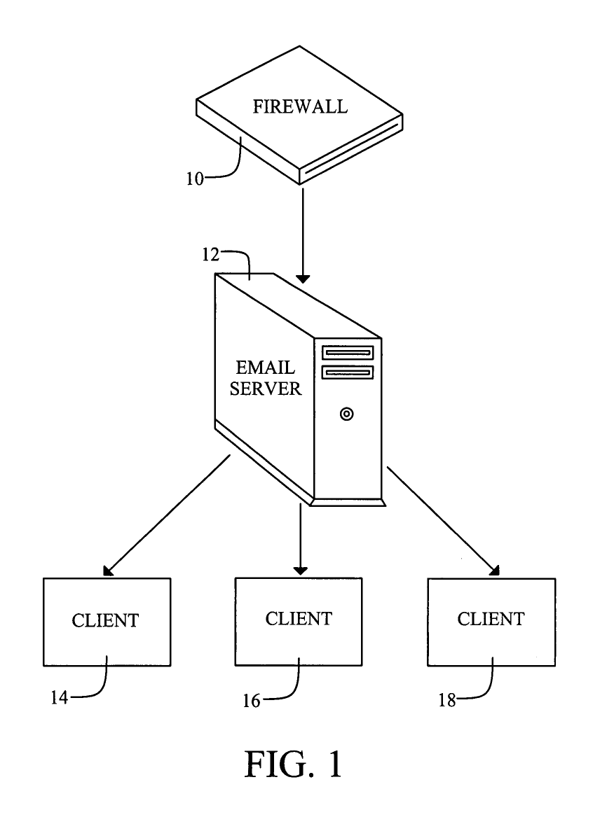

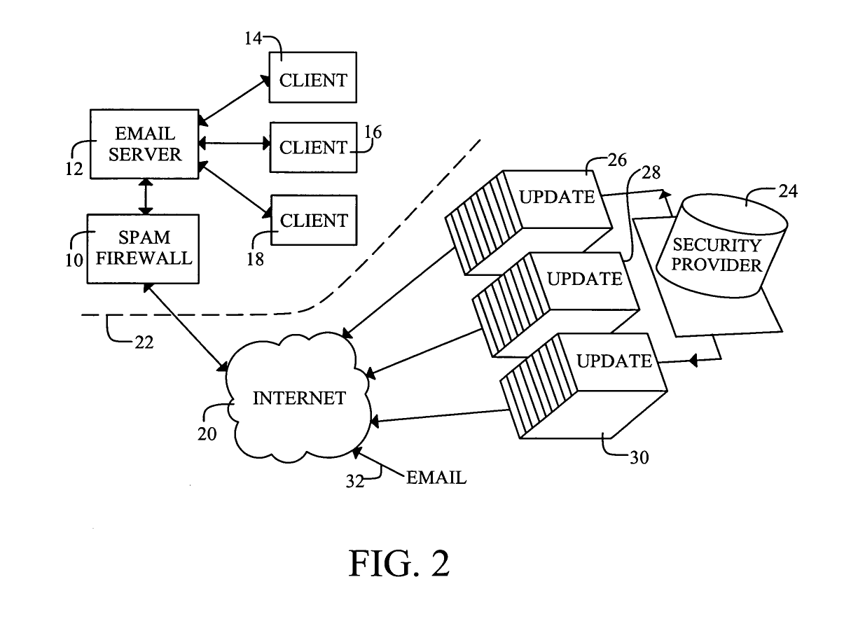

With reference to FIG. 2, the spam firewall 10 of FIG. 1 is shown as being connected to the global communications network referred to as the Internet 20. The spam firewall may be a networking component for a corporation or for an Internet Service Provider (ISP) which is represented by dashed lines 22. For simplicity, a number of components are not shown, such as a gateway and routers. As is known in the art, the spam firewall will regulate passage of electronic communications to the email server 12. In some applications, the spam firewall will also apply rules to outgoing emails. The email server supports a number of clients 14, 16 and 18, only three of which are shown in FIG. 2. The clients may take various forms, such as desktop computers, laptop computers, PDAs, and cellular phones having email capability. While the invention will be described primarily with reference to detecting spam within email, the invention applies equally to other types of electronic communications in which spam may be transmitted.

In the embodiment shown in FIG. 2, centralized updates of spam definitions and rules from a security provider 24 are enabled by connection to the Internet 20 via update facilities 26, 28 and 30. The use of more than one update facility is not significant to the invention. When the scale of the security provider 24 is large, the use of multiple update facilities increases speed. Moreover, if the responsibilities of the different facilities are territorially based, different spam-detection rules may be applied to different territories. This may be significant for types of spam that are unique to geographical areas. Additionally, the spam-detection rules will vary on the basis of the language of interest. While only one corporation 22 is shown in FIG. 1 as being a receiving site for updates, there may be a large number of such sites.

In FIG. 2, line 32 represents connections to sources of email messages intended for the clients 14, 16 and 18. The spam firewall 10 determines which email messages are allowed to reach the targeted clients. The firewall may be a separate device or may be integrated with other network functionalities. Often, a spam firewall will implement multiple layers of defense, such as keyword blocking, Bayesian filtering, blacklist and whitelist checking, and keyword scoring. The spam firewall may include optical character recognition (OCR) capability that is applied to images related to the incoming email messages. The images may be attachments. Alternatively, the images may be separately stored, but automatically downloaded as a result of code incorporated into an email message. While it is possible for an individual spam firewall 10 to provide automated updates of spam-detection rules, the preferred embodiment of the invention is one in which the automated rule generation occurs at the security provider 24.

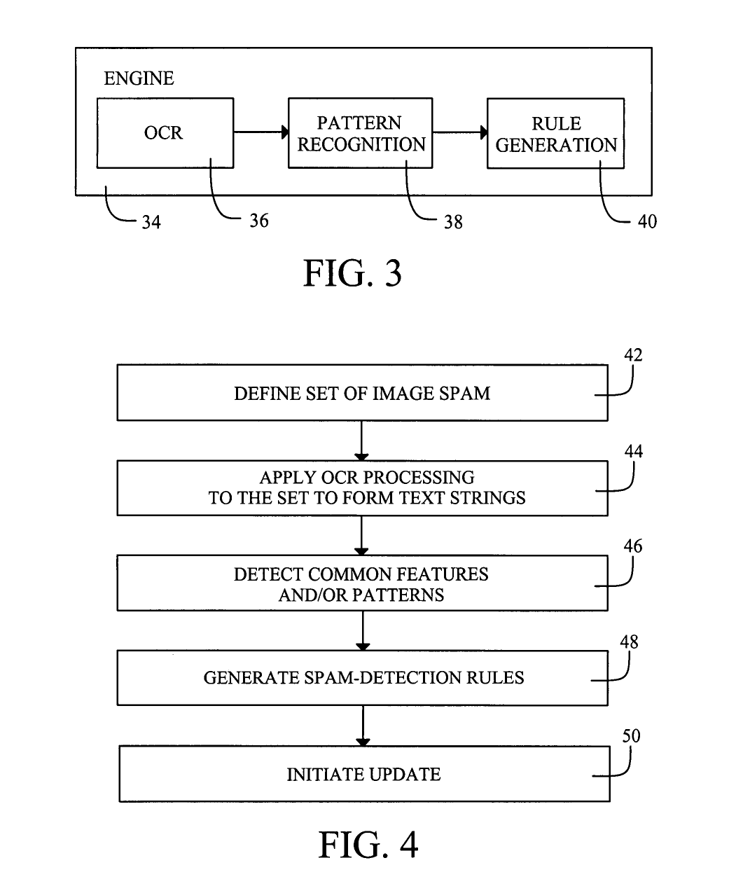

Referring now to FIG. 3, a rule generation engine 34 in accordance with the invention may be considered to have at least three components. An OCR component 36 may merely be computer programming designed to translate images containing text into text strings. In spam detection applications, there are advantages to segmenting a single spam image, so that multiple text strings are formed for each image having more than one segment that contains text. While conventional OCR software uses white space to recognize text in an appropriate order, the current generation of spam images is designed to defeat conventional OCR capability. Thus, a more sophisticated formatting, such as delineating “segments” or zones, will increase the likelihood that textual content is properly identified. However, an advantage of the present invention is that the analysis is not restricted to a proper understanding of the textual content. Rather, features and patterns within the OCR output are recognized at the recognition component 38. Feature extractions and pattern extractions from the OCR component are recognized and then employed by a rule generation component 48 for determining the spam-detection rule updates.

The text strings that are output from the OCR component 36 may take any of a number of different forms. For example, the text strings may be ASCII (American Standard Code for Information Interchange), RTF (Rich Text Format), or a text string format compatible with a commercially available word processing program.

FIG. 4 shows one possible sequence of steps for implementing the present invention within the structural environment illustrated in FIGS. 1-3. Firstly, a set of image spam is defined at step 42. In the embodiment in which the automated generation of spam-detection rules is used in defining updates, the spam images may be a collection of images which were submitted from various networks, such as the corporation 22 of FIG. 2. That is, if spam images are undetected using the current spam-detection rules, the images may be collected after identification by an administrator of a network. When a sufficient number of such spam images are collected, they may be used in the present invention to increase the effectiveness of the identification by the firewall. The initial spam-detection rules can be formed using conventional techniques, but the rules may allow “false negatives” (i.e., may not recognize all spam images) or may be rendered less effective by changes in the design of the spam images for the purpose of circumventing the original rules.

The significant difference between spam detection as applied at the firewall 10 of FIG. 2 and the implementation of step 42 at the security provider 24 is that the set of images of concern has been previously identified as being spam. That is, both legitimate email and spam email will be inspected at the spam firewall 10, while only spam email is needed for the purpose of updating the rules. However, there may be advantages to utilizing both legitimate email and spam email. For example, Bayesian analysis may be applied to determining the appropriateness of rule updates. In addition to the use of “false negatives,” legitimate email containing images, particularly “false positives,” may be submitted to the OCR processing. Probabilities can be established and a probability threshold can be used to reduce the chance of an ineffective update.

In the implementation of the invention, spam rules may also be updated on the basis of images which are neither known to be spam-free nor known to be spam. The system may be configured for auto-learning. If a particular text pattern has been detected to be in a threshold number of images, the text pattern may be labeled as being suspect. Then, the suspect text pattern may be tested against standard text-only email messages and the spam rules that are applied to such messages. Alternatively, the images that contain the suspect text pattern may be presented to an administrator for consideration.

At step 44, the OCR processing is applied to the set of identified image spam. As a consequence, text strings are formed. Pixel-to-pixel image data representative of text is converted to machine-readable text strings in a particular format, such as ASCII or RTF.

At step 46, features and patterns that are common to a number of the images within the set are detected. There may be a “whitelist” of acceptable features and patterns, so that legitimate features and patterns are not improperly used as the basis for identifying spam. In a preferred embodiment, the features and patterns that are identified are those that are “irregular” in some degree. As an example, all words which are not contained within a predefined dictionary may be tagged and counted. In conventional OCR processing, a baseline for a string of text is identified. A technique for avoiding detection at a spam firewall, such as the firewall 10 in FIG. 2, is to misalign letters that form a word or a sentence. Then, the conventional OCR processing will be unable to properly identify the word. As an example, a letter “O” that is misaligned relative to a baseline may be improperly identified as the Greek letter “φ.” If this Greek letter is repeatedly contained within the images of the set defined at step 42, the common feature will be used as a basis for detecting spam. Similarly, consistent misspellings within the set will be identified.

An update of spam-detection rules at a local site or at a number of remote sites is generated at step 48. The identification of common features and patterns within the image spam is used as the basis for generating the rules. The automatic generation of rules is based upon at least one algorithm. As one possibility, a “frequency of occurrence” algorithm may be applied using a threshold number of detected occurrences of a features or pattern. Thus, if a threshold of fifty occurrences of an undefined word is surpassed, the common feature or pattern may be placed on a “blacklist” for the classification of an email message as being spam. Rather than a frequency of occurrence, the algorithm may be percentage based, such as the determination that an “irregular” feature or pattern is spam when ten percent of the images within the set contain the feature or pattern. As applied to text only, an “irregularity” is an occurrence not consistent with a dictionary of terms.

A “similarity to an existing rule” algorithm may be applied. If the particular feature or a particular pattern is identified as being common to a number of the images identified as spam, a comparison may be made to existing rules. In a non complex example, the common feature may be a pluralization of a word which has already been identified on the blacklist. Then, the original blacklist rule may be modified to catch both the single form and the plural form of the word. This also applies to endings of verbs contained in a blacklist. Only slightly more difficult, a word may be intentionally changed by spammers in order to evade detection, such as the addition of different numbers at the end of a word commonly associated with spam. It is within the skill of persons in the art to modify rules to include truncations of words, so that a single rule can take the place of multiple rules which would cover each possibility.

As previously noted, Bayesian analysis may be applied to determine the appropriateness of new or “optimized” rules. Tokens generated from the “false negatives” determine upward movement of probabilities, while the tokens generated from “false positives” and other known legitimate email provide the basis for adjusting the probabilities downwardly. Only rules which exceed a threshold level of probability may be passed to the next step of the process. In an embodiment of the invention, the relevant information may be maintained as an OCR Bayesian database, which may be delivered from a central site as an update for remote sites, as described with reference to FIG. 2.

Finally, at step 50, the automatically generated rules are used as an update for the appropriate firewall or firewalls. In FIG. 2, the security provider 24 utilizes at least one update facility 26, 28 and 30 to distribute the spam-detection rules to the appropriate firewalls. The form of the rules is not significant to the invention. As one possibility, the rules may take the form of “regular expressions,” which are known in the art.

In addition to email messages, the spam-detection processing described with reference to FIGS. 1-4 may be applied to other types of electronic communications. To the extent that spam may be included within Instant Messages (IM), the automated generation of rules may be used to more effectively detect the spam. As another possibility, electronic communications in the form of facsimile transmissions may be monitored and the automatic generation of rules may be periodically employed.

What is claimed is:

1. A computer-implemented method of enabling spam detection comprising:
identifying a set of images as being spam;
applying optical character recognition (OCR) techniques to said images to provide text strings representative of content of individual said images;
applying automated techniques to said text strings to identify common text-related features and patterns of a plurality of said text strings, wherein said common text-related features and patterns are determined to be indicative of spam;
generating spam-detection rules based on identifications of said common text-related features and patterns; and
applying said spam-detection rules to electronic communications to detect occurrences of spam within said electronic communications.

2. The computer-implemented method of claim 1 wherein applying said spam-detection rules includes transmitting said spam-detection rules to a plurality of spam firewalls of a plurality of independent networks.

3. The computer-implemented method of claim 2 wherein identifying said set of images includes receiving said images from said independent networks as spam which was not identified as being spam by said spam firewalls.

4. The computer-implemented method of claim 3 wherein said spam-detection rules are transmitted to said spam firewalls as an update to previously employed spam-detection rules.

5. The computer-implemented method of claim 1 wherein applying said spam-detection rules includes determining whether email messages contain spam.

6. The computer-implemented method of claim 1 wherein identifying said common text-related features includes determining occurrences of specific words not found in a dictionary which is accessible during application of said automated techniques.

7. The computer-implemented method of claim 1 wherein identifying said common text-related features includes determining occurrences of words containing symbols not consistent with spelling words with respect to a particular language.

8. The computer-implemented method of claim 1 wherein applying automated techniques includes applying a threshold to a frequency of occurrences of said text-related features and patterns.

9. The computer-implemented method of claim 1 wherein applying automated techniques includes updating existing rules to optimize said existing rules on a basis of said common text-related features and patterns.

10. The computer-implemented method of claim 1 wherein applying said OCR techniques includes forming a plurality of said text strings for at least one said image, including defining segments of said image and forming a separate said text string for each said segment.

11. The computer-implemented method of claim 1 wherein generating and applying said spam-detection rules includes utilizing Bayesian analysis to determine probabilities as to whether said spam-detection rules are effective in detecting spam, said Bayesian analysis including establishing a threshold of probability which must be met by each said spam-detection rule.

12. A system for determining spam-detection rules comprising:
a supply of known image spam, each said known image spam including an image designated as being spam;
an optical character recognition (OCR) component having an input to receive said known image spam, said OCR component being configured to form at least one text string for each said known image spam that includes text;
a pattern recognition component connected to said OCR component to receive said text strings, said pattern recognition component being configured to identify common text-related features and patterns among text strings formed at said OCR component; and
a rules generation component connected to said pattern recognition component, said rules generation component being configured to generate spam-detection rules on a basis of said common text-related features and patterns.

13. The system of claim 12 further comprising an update facility to distribute said spam-detection rules to a plurality of spam firewalls of independent networks.

14. The system of claim 12 wherein said pattern recognition is computer programming configured to detect misspellings of words.

15. The system of claim 12 wherein said supply of known image spam is a storage of email.

16. The system of claim 12 wherein said rules generation component is configured to apply Bayesian analysis.

17. A computer-implemented method comprising:
utilizing spam-detection rules to identify spam;
collecting spam images which remain unidentified as spam by said spam-detection rules;
applying OCR processing to said spam images to generate text strings representative of text contained in said spam images;
using automated techniques to identify commonalities among said text strings, where said commonalities are inconsistent with language construction;
generating additional spam-detection rules based on said commonalities; and
providing an update for subsequent detections of spam.

18. The computer-implemented method of claim 17 wherein identifying said commonalities includes detecting misspellings within a plurality of said spam images.

19. The computer-implemented method of claim 17 wherein generating said additional spam-detection rules includes applying a frequency of occurrence algorithm.

20. The computer-implemented method of claim 17 wherein said spam-detection rules are applied to email messages.
